(19) United States
(12) Patent Application Publication
(10) Pub. No.: US 2006/0153400 A1
(43) Pub. Date: Jul. 13, 2006

(54) Microphone and sound amplification system

(75) Inventors: Hiroaki Fujita, Hamamatsu-shi (JP); Hiraku Okumura, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-Shi (JP)

(21) Appl. No.: 11/330,549

(22) Filed: Jan. 11, 2006

(30) Foreign Application Priority Data
Jan. 12, 2005 (JP) 2005-004982

(51) Int. Cl. H04B 3/20; H04R 3/00

(52) U.S. Cl. 381/95; 381/66

(57) ABSTRACT

Microphone includes: a microphone element; a simulative feedback signal generation section that generates a simulative feedback signal simulating a feedback signal generated by a sound, produced via a speaker, returning the microphone element; and an arithmetic operator that subtracts the simulative feedback signal, generated by the simulative feedback signal generation section, from a sound signal collected by the microphone element, to thereby output the subtraction result as a residual signal. The residual signal output by the arithmetic operator is supplied to an amplifier device of the speaker as an output signal of the microphone. The simulative feedback signal generation section includes a delay circuit that delays the residual signal, output by the arithmetic operator, by a given time, and an adaptive filter that generates the simulative feedback signal by filtering a previous residual signal delayed by the delay circuit. The adaptive filter updates a filter coefficient on the basis of the previous residual signal delayed by the delay circuit and a current residual signal output by the arithmetic operator.

### BACKGROUND OF THE INVENTION

The present invention relates to microphones capable of preventing howling, and sound amplification systems suitable for installation in auditoriums, halls, etc. and capable of preventing howling.

Generally, in cases where a sound amplification apparatus is installed in an auditorium, hall or the like, sounds output from a speaker are fed back to a microphone via a sound path having a given transfer function. Namely, a closed loop is formed by the microphone, amplifier, speaker, sound path and microphone. If the gain of the closed loop exceeds one, a sound returning from the speaker to the microphone would be enhanced to cause howling. To reliably prevent such howling, there have been proposed howling cancellers which prevent occurrence of howling using an adaptive digital filter (hereinafter “adaptive filter”) (see, for example, “Howling Canceller in Sound Amplification System Using LMS Algorithm”, by Inazumi, Imai and Konishi, in Proceedings at Meeting of Acoustical Society of Japan, pp. 417-418 (March, 1991)).

FIG. 11 is a diagram showing the above-mentioned howling canceler. Microphone 301 and speaker 304 are installed in a same sound space, such as an auditorium or hall. Sound signal input via the microphone 301 is amplified via a front-end microphone amplifier and then converted into a digital signal y(k) via an A/D converter.

The signal y(k) is supplied via an adder 302 to an amplifier 303. G(z) represents a transfer function of the amplifier 303. Signal x(k) output from the amplifier 303 is converted via a D/A converter into an analog signal and then audibly reproduced or sounded through a speaker 304.

Sound audibly reproduced through the speaker 304 returns (or is fed back) to the microphone 301 via a sound feedback path 305 leading from the speaker 304 to the microphone 301. H(z) represents a transfer function of the sound feedback path 305. Feedback signal d(k), fed back via the sound feedback path 305, is input to the microphone 301 along with a source sound signal s(k) uttered by a human speaker or the like. The microphone 301 converts the input sounds into digital representation and outputs the converted result as a signal y(k).

In such a sound amplification apparatus, a closed loop is formed by the microphone 301, amplifier 303, speaker 304, sound feedback path 305 and microphone 301. If the gain of the closed loop exceeds one, the feedback signal d(k) is enhanced to produce unwanted howling. In order to prevent such howling, the sound amplification apparatus of FIG. 11 includes a howling canceller that comprises a delay circuit 306, adaptive filter 307 and adder 302.

Delay circuit 306 imparts an output signal x(k) of the amplifier 303 with a delay time τ corresponding to a time delay of the sound feedback circuit 305 and outputs the resultant delayed signal x(k-τ) to the adaptive filter 307. As shown in FIG. 12, the adaptive filter 307 includes a filter section 307a and a filter coefficient estimation section 307b. The signal x(k-τ) is input to both the filter section 307a and the filter coefficient estimation section 307b.

In the filter section 307a, there is set a filter coefficient such that the signal supplied from the microphone 301 is attenuated with a transfer function F(z) simulative of the transfer function H(z) of the sound feedback path 305. Thus, the adaptive filter 307 outputs a signal do(k) obtained by filtering the signal x(k-τ) with the transfer function F(z) that is simulative of the transfer function H(z) of the sound feedback path 305; therefore, the output signal do(k) is simulative of the feedback signal d(k) re-input from the speaker 304 to the microphone 301 by way of the sound feedback path 305.

The adder 302 subtracts the signal do(k), which is simulative of the feedback signal d(k), from the signal y(k) input via the microphone 301 (in this case, the signal y(k) is a combination of the sound source signal and feedback signal). As a consequence, the feedback signal d(k) is removed from the input signal so that howling can be canceled out.

The filter coefficient estimation section 307b successively updates the filter coefficient of the filter section 307a, using an adaptive algorithm and on the basis of the signals x(k-τ) and e(k), so that the transfer function F(z) approximates the transfer function H(z) of the sound path 305. In this way, it is possible to provide the signal do(k) simulative of the feedback signal d(k) and prevent howling by use of such a signal do(k).

With the howling canceller disclosed in the above-identified literature (“Prevention of Howling in Sound Amplification System Using LMS Algorithm”), there is a need to supply the adaptive filter with both of the input signal given from the microphone and output signal to be supplied to the speaker. Thus, although the howling canceller can be incorporated into an amplifier device in advance, it is extremely difficult to incorporate the howling canceller into an existing amplifier device. Therefore, in order to effectively cancel howling, it is necessary to purchase another amplifier device with the howling canceler incorporated therein, which would therefore result in increased cost.

Further, even the amplifier device with the disclosed howling canceler incorporated therein has only one such howling canceler. Thus, in a case where a plurality of microphones are connected to the amplifier device, the howling canceler performs howling-canceling operations on a just single signal obtained by combining signals input via all of the microphones. Therefore, the disclosed howling canceler can not separately deal with individual feedback signals to be re-input to the plurality of microphones, so that it is difficult for the disclosed howling canceler to effectively cancel howling.

### SUMMARY OF THE INVENTION

In view of the foregoing, it is an object of the present invention to provide an improved microphone and sound amplification system which can reliably cancel howling even where the microphone is connected to an existing amplifier device or where a plurality of the microphones are connected to a single amplifier device.

In order to accomplish the above-mentioned object, the present invention provides an improved microphone, which comprises: a microphone element; a simulative feedback signal generation section that generates a simulative feedback signal simulating a feedback signal generated by a sound, produced via a speaker, entering the microphone element; and an arithmetic operator that subtracts the simulative feedback signal, generated by the simulative feedback signal generation section, from a sound signal collected by the microphone element, to thereby output the subtraction result as a residual signal. The residual signal output by the arithmetic operator is supplied to an amplifier device of the speaker as an output signal of the microphone.

According to the present invention, the simulative feedback signal generated by the simulative feedback signal generation section is subtracted from the sound signal collected by the microphone element, and the subtraction result is output as the residual signal. The residual signal is given to the amplifier device of the speaker, so that it is possible to eliminate the feedback signal component, generated by the speaker-produced sound entering the microphone element, and thereby cancel howling. Further, because the separate microphone is provided with its own simulative feedback signal generation section which generates the simulative feedback signal that is simulative of the feedback signal generated by a sound, produced via the speaker, entering (or re-input to) the microphone element and the simulative feedback signal (component) is subtracted from the sound signal picked up by the microphone, an existing amplifier device, having no noise canceller function, can be used as-it as the amplifier device of the speaker in the sound amplification system. Further, even where a plurality of microphones are connected to the amplifier device of the speaker, howling-canceling processing can be performed separately for each of the microphones with characteristics specific to the microphone.

Preferably, the simulative feedback signal generation section includes: a delay circuit that delays the residual signal, output by the arithmetic operator, by a given time; and an adaptive filter that generates the simulative feedback signal by filtering a “previous residual signar” delayed by the delay circuit. Further, the adaptive filter updates a filter coefficient on the basis of the previous residual signal delayed by the delay circuit and a current residual signal output by the arithmetic operator. Thus, on the basis of the previous residual signal output from the delay circuit and the current residual signal output from the arithmetic operator, the adaptive filter automatically updates the filter coefficient so as to allow the transfer function of the adaptive filter itself to agree with or approximate the transfer function of the sound path leading from the speaker to the microphone.

Preferably, the simulative feedback signal generation section further includes, at a stage preceding the delay circuit, a simulating amplifier filter that simulates a transfer function of the amplifier device of the speaker, and the simulative feedback signal generation section filters the residual signal, output by the arithmetic operator, by means of the simulating amplifier filter and then supplies the thus-filtered residual signal to the delay circuit. With the provision of the simulating amplifier filter simulating the transfer function of the amplifier device of the speaker, the feedback transfer function (filter coefficient) of the adaptive filter following the simulating amplifier filter can be easily identified and thus the feedback transfer can be simulated accurately and promptly, with the result that occurrence of howling can be reliably prevented. The transfer function of the amplifier device of the speaker may be preset assuming an ordinary amplifier device.

Preferably, the microphone of the present invention further comprises: a memory storing a plurality of transfer functions that are respectively simulative of characteristics a plurality of types of amplifier devices usable in the speaker; and a selector that selects any one of the transfer functions from the memory and sets the selected transfer function in the simulating amplifier filter. The plurality of transfer functions may be prestored assuming different sizes of various amplifier devices, such as those to be used in large and small halls, auditoriums, meeting rooms and karaoke rooms. By selectively switching between the transfer functions depending on the place where the microphone is used, it is possible to facilitate the identification of the feedback transfer function (filter coefficient) of the adaptive filter following the simulating amplifier filter.

According to another aspect of the present invention, there is provided an improved sound amplification system, which comprises: a microphone including a sound-collecting microphone element; an amplifier device including a signal processing circuit that amplifies, and/or adjusts the sound quality of, a sound signal input via the microphone; and a speaker that audibly reproduces or sounds the sound signal output by the amplifier device. The microphone further includes a simulative feedback signal generation section that generates a simulative feedback signal simulating a feedback signal generated by a sound, produced via a speaker, returning or re-input to the microphone element; an arithmetic operator that subtracts the simulative feedback signal, generated by the signal simulative feedback generation section, from the sound signal collected by the microphone element, to thereby output the subtraction result as a residual signal, the residual signal output by the arithmetic operator being supplied to the amplifier device as an output signal of the microphone; and a simulating amplifier filter that filters the residual signal, output by the arithmetic operator, with a transfer function simulative of a characteristic of the amplifier device, the simulative feedback signal generation section generating the simulative feedback signal on the basis of an output signal of the simulating amplifier filter.

With the provision, in the microphone, of the simulating amplifier filter that simulates the transfer function of the amplifier device of the speaker, the feedback transfer function (filter coefficient) of the adaptive filter following the simulating amplifier filter can be easily identified and thus the feedback transfer can be simulated accurately and promptly, with the result that occurrence of howling can be reliably prevented.

Preferably, in the sound amplification system of the present invention, the amplifier device further includes a collection section that collects a parameter, such as a gain setting or sound quality adjustment value, set or adjusted by the signal processing circuit, and a transmitter section that transmits to the microphone the parameter collected by the collection section. The microphone further includes a receiver section that receives the gain setting or sound quality adjustment value transmitted by the transmitter section, and a setting section that reproduces a transfer function of the amplifier device on the basis of the gain setting or sound quality adjustment value received by the receiver section and then sets the reproduced transfer function in the simulating amplifier filter.

Because the parameter, such as the gain setting or sound quality adjustment value, in the amplifier device is transmitted and the transfer function of the amplifier device is reproduced on the basis of the transmitted parameter and set in the simulating amplifier filter, the transfer function of the amplifier device can be simulated reliably and easily by the simulating amplifier device.

In another preferred implementation, the amplifier device further includes a measurement section that measures a transfer function of the amplifier device, and a transmitter section that transmits to the microphone data indicative of the transfer function measured by the measurement section. The microphone includes a receiver section that receives the data indicative of the transfer function transmitted by the transmitter section, and a setting section that sets the transfer function, represented by the received data, in the simulating amplifier filter.

With the arrangements that the transfer function of the amplifier device is actually measured, data indicative of the measured transfer function is transmitted to the microphone and the transfer function of the amplifier device is reproduced on the basis of the transmitted data and set in the simulating amplifier filter, the transfer function of the amplifier device can be simulated reliably and easily by the simulating amplifier device.

Preferably, in the sound amplification system, the amplifier device further includes: a detector that detects a sound signal level input via the microphone; a signal blockage section that, when the sound signal level detected by the detector is less than a predetermined threshold value, blocks sound signal input from the microphone to the amplifier device and sound signal output from the amplifier device to the speaker; and a measurement signal supply section that, during the blockage, by the signal blockage section, of the sound signal input and output, supplies a predetermined measurement signal to the amplifier device, the measurement signal supply section causing the measurement section to measure a transfer function of the amplifier device in response to the measurement signal supplied.

According to such inventive arrangements, the measurement of the transfer function of the amplifier device is performed by the measurement section when the input sound signal level is less than the predetermined threshold value, i.e. when it can be judged that no source sound or the like has been input via the microphone. In this case, the input and output to and from the amplifier device is blocked, and the predetermined measurement signal, such as white noise, generated within the system is input to the amplifier device, so that the transfer function of the amplifier device is measured with the predetermined measurement signal input to the amplifier device, i.e. in such condition as to facilitate accurate measurement of the transfer function. Consequently, the transfer function of the amplifier device can be measured accurately and reproduced via the microphone.

According to still another aspect of the present invention, there is provided an improved sound amplification system, which comprises: a microphone including a sound-collecting microphone element; an amplifier device including a signal processing circuit that amplifies, and/or adjusts sound quality of, a sound signal input via the microphone and a speaker that audibly reproduces the sound signal output by the amplifier device. The amplifier device further includes a transmitter section that transmits to the microphone the sound signal amplified and/or adjusted in sound quality by the signal processing circuit. The microphone further includes: a simulative feedback signal generation section that generates a simulative feedback signal simulating a feedback signal generated by a sound, produced via a speaker, entering (i.e., returning to) the microphone element; an arithmetic operator that subtracts the simulative feedback signal, generated by the simulative feedback signal generation section, from the sound signal collected by the microphone element, to thereby output the subtraction result as a residual signal, the residual signal output by the arithmetic operator being supplied to the amplifier device as an output signal of the microphone; and a receiver section that receives the signal transmitted by the transmitter section of the amplifier device, the simulative feedback signal generation section generating the simulative feedback signal on the basis of the signal received by the receiver section.

With the inventive arrangements that the amplifier device further includes the transmitter section that transmits to the microphone the sound signal amplified and/or adjusted in sound quality by the signal processing circuit, and that the microphone receives the transmitted sound signal and the simulative feedback signal generation section generates the simulative feedback signal on the basis of the received signal, the simulative feedback signal can be generated using the output signal of the amplifier device (i.e. signal readily simulating the signal processing in the amplifier device). Because the transfer function of the amplifier device is accurately reproduced and used by the microphone to generate the simulative feedback signal, the present invention can appropriately cancel unwanted howling.

With the arrangements stated above, the microphone of the present invention can reliably cancel howling even where it is connected to an existing amplifier device. Further, even in the case where a plurality of the microphones are connected to a single amplifier device, the present invention can cancel a feedback sound input to each of the microphones, to thereby reliably cancel howling.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

For better understanding of the objects and other features of the present invention, its preferred embodiments will be described hereinbelow in greater detail with reference to the accompanying drawings, in which:

FIG. 1 is a block diagram of a sound amplification apparatus in accordance with a first embodiment of the present invention;

FIG. 2 is a block diagram showing in detail a construction of a howling canceler employed in the sound amplification apparatus of FIG. 1;

FIG. 3 is a diagram showing transfer characteristics of the sound amplification apparatus according to the first embodiment;

FIG. 4 is a block diagram of a sound amplification apparatus in accordance with a second embodiment of the present invention;

FIG. 5 is a diagram showing transfer characteristics of the sound amplification apparatus according to the second embodiment;

FIG. 6 is a block diagram showing a modification of the sound amplification apparatus according to the second embodiment of the present invention;

FIG. 7 is a block diagram of a sound amplification apparatus in accordance with a third embodiment of the present invention;

FIG. 8 is a block diagram showing a modification of the sound amplification apparatus according to the third embodiment of the present invention;

FIG. 9 is a block diagram showing another modification of the sound amplification apparatus according to the third embodiment of the present invention;

FIG. 10 is a block diagram of a sound amplification apparatus in accordance with a fourth embodiment of the present invention;

FIG. 11 is a block diagram showing a circuit construction of a conventional sound amplification apparatus with an adaptive howling canceler incorporated therein; and

FIG. 12 is a block diagram showing in detail a construction of the adaptive howling canceler employed in the conventional sound amplification apparatus.

### DETAILED DESCRIPTION OF THE INVENTION

### FIRST EMBODIMENT

FIG. 1 is a block diagram of a sound amplification apparatus in accordance with a first embodiment of the present invention. As shown, the sound amplification apparatus comprises: a microphone 100 including a sound-collecting microphone element 1, A/D converter, howling canceller HC, D/A converter and connecting terminal 3a; an amplifier device 200 including a connecting terminal 3b, microphone amplifier 4, equalizer 5 and power amplifier 6; and a speaker 7. Note that a microphone amplifier may be provided between the microphone element 1 and the A/D converter, in which case the amplifier device 200 need not include the microphone amplifier 4.

The howling canceller HC includes an adder 2 between the A/D converter and the D/A converter, an adaptive filter 9 for supplying a simulative feedback signal to the adder 2, and a delay circuit 8 for delaying a residual signal, output from the adder 2, by a predetermined time and supplying the thus-delayed residual signal to the adaptive filter 9.

Voice or sound signal output from the microphone element 1 is converted via the A/D converter into a digital signal, delivered via the adder 2 to the D/A converter and then transferred to the connecting terminal 3a as an analog sound signal. The connecting terminals 3a and 3b, each of which is for example an XLR terminal, are interconnected to permit transfer of the sound signal. Note that the connecting terminals 3a and 3b may be implemented in any suitable form as long as they permit transfer of the sound signal; for example, the connecting terminals 3a and 3b may be a transmitter and receiver, respectively, to transfer the sound signal wirelessly.

The signal transferred to the connecting terminal 3b is delivered via the microphone amplifier 4 to the equalizer 5 for sound quality adjustment, and then the thus-adjusted signal is transferred via the power amplifier 6 to the speaker 7. The speaker 7 produces a sound from the transferred sound signal, i.e. audibly reproduces the transferred sound signal. At least part of the sound audibly produced by the speaker 7 (i.e., “speaker-produced sound”) returns to the microphone element 1 to be picked up again by the microphone element 1.

Here, the howling canceller HC is constructed to simulate, by means of the delay circuit 8 and adaptive filter 9, transfer characteristics of a series of sound transfer paths via which each sound signal input via the microphone element 1 is transferred in the sound space where are installed the amplifier device 200, speaker 7 and microphone 100 and then again input to the microphone element 1. The delay circuit 8 is constructed to impart a time delay corresponding to an estimated time delay of a feedback signal returning from the speaker 7 to the microphone element 1. The value of the time delay is preset assuming an environment in which the microphone element 1 is used. Alternatively, the time delay may be actually measured in the environment in which the microphone element 1 is used, so as to set the measured value as the value of the time delay.

The adaptive filter 9, which is a filter for simulating the transfer function of the sound transfer paths, filters the residual signal delayed by the delay circuit 8. The thus-filtered signal output from the adaptive filter 9 is supplied to the adder 2 as a simulative feedback signal.

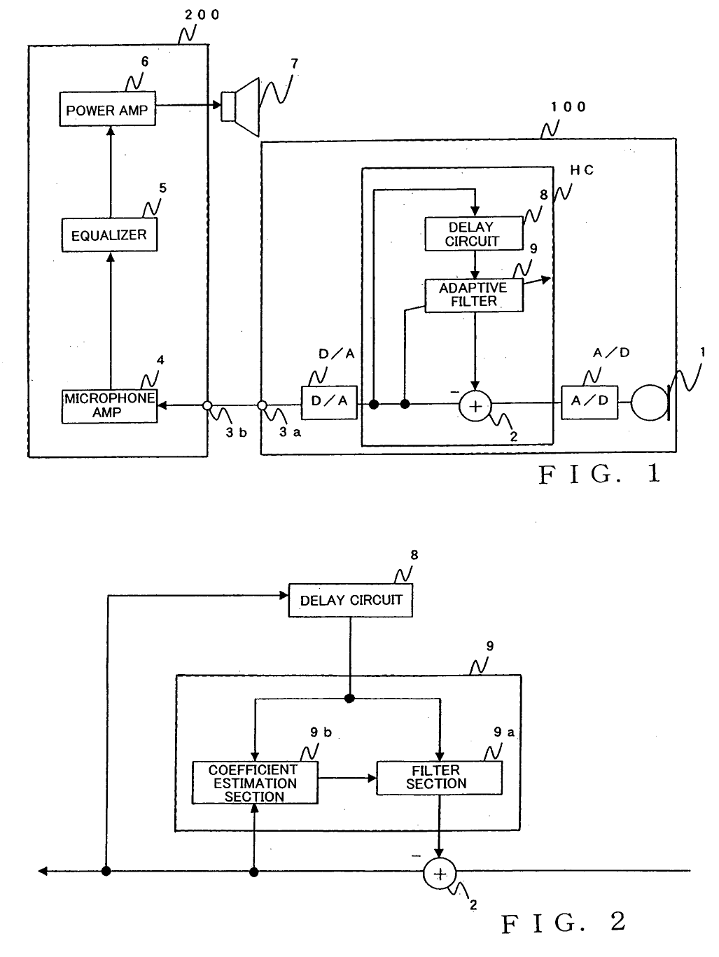

As shown in FIG. 2, the adaptive filter 9 includes a filter section 9a and a filter coefficient estimation section 9b, and the delayed residual signal from the delay circuit 8 is supplied to both the filter section 9a and the filter coefficient estimation section 9b. The filter section 9a filters the supplied residual signal and supplies the resultant filtered signal to the adder 2. In turn, the adder 2 subtracts the filtered signal (simulative feedback signal), supplied from the filter section 9a, from the input signal (i.e., picked-up sound signal including the actual feedback signal component) from the microphone element 1. In this manner, the feedback signal component is removed from the picked-up sound signal.

The filter coefficient estimation section 9b detects a removal error of the feedback signal component on the basis of the previous residual signal delayed by the delay circuit 8 and the current residual signal directly input from the output terminal of the adder 2, and then it automatically updates the transfer function of the filter section 9a so as to allow the simulative feedback signal (hereinafter referred to simply as “simulative signal”) to agree with or approximate the feedback signal.

The transfer function updating by the filter coefficient estimation section 9b is executed using an adaptive algorithm that may be, for example, an LMS (Least Mean Square) algorithm.

Next, a description will be given about behavior of the above-described sound amplification apparatus.

FIG. 3 is a diagram explanatory of transfer characteristics of the sound amplification apparatus in accordance with the first embodiment of the present invention. As shown, the signal y(k) input via the microphone element 1 is supplied to the adder 2. The adder 2 subtracts, from the input signal y(k), the output signal of the adaptive filter 9, to thereby output the residual signal e(k). The residual signal e(k) is supplied to an amplifying path 51 via the connecting terminals 3a and 3b. The amplifying path 51 represents a combination of the signal transfer paths leading from the microphone element 1 to the speaker 7. Reference character G(z) represents a transfer function of the amplifying path 51.

Signal x(k) output from the amplifying path 51 is transferred to the speaker 7, via which it is audibly reproduced or sounded. Sound thus produced via the speaker 7 returns to the microphone element 1 via a sound feedback path 52. The sound feedback path 52 is a sound path leading from the speaker 7 to the microphone element 1. H(z) represents a transfer function of the sound feedback path 52. The feedback signal d(k) returned via the sound feedback path 52 is input to the microphone element 1 along with a sound source signal s(k) generated by a sound source, such as a human speaker, and then the microphone element 1 again outputs these signals as the signal y(k).

The residual signal e(k) output from the adder 2 is also supplied to the delay circuit 8. The delay circuit 8 imparts a time delay to the supplied residual signal e(k) to thereby output the delayed residual signal as a previous residual signal; in this example, the delay circuit 8 imparts the supplied residual signal with a time delay corresponding to an estimated time delay of the feedback signal returning from the speaker 7 to the microphone element 1. The time-delayed, previous residual signal e(k-τ) output from the delay circuit 8 is supplied to the adaptive filter 9.

The adaptive filter 9, as seen in FIG. 2, includes the filter section 9a and filter coefficient estimation section 9b, and the previous delayed residual signal e(k-τ) output from the delay circuit 8 is supplied to both the filter section 9a and the filter coefficient estimation section 9b. The filter section 9a outputs, to the adder 2, the simulative signal do(k) that is simulative of the feedback signal d(k) returning from the speaker 7 to the microphone 1. The adder 2 subtracts the simulative signal do(k) from the signal y(k) re-input via the microphone element 1, to thereby output the current residual signal e(k). The simulative signal do(k), which is simulative of the feedback signal d(k), is determined in accordance with the transfer function F(z) and on the basis of the previous residual signal e(k-τ) output from the delay circuit 8.

The filter coefficient estimation section 9b updates the filter coefficient of the filter section 9a so as to allow the simulative signal do(k), which is simulative of the feedback signal d(k), to agree with or approximate the actual feedback signal d(k), on the basis of the previous residual signal e(k) output from the delay circuit 8 and the current residual signal e(k) obtained by subtracting the simulative signal do(k) from the signal y(k) re-input via the microphone element 1 to the amplifying path 51 and using the adaptive algorithm. For example, an LMS algorithm is used as the adaptive algorithm. If the square mean value j of the residual signal e(k) is E[e(k)²] (note that E[-] is an expected value), a filter coefficient to minimize the value J is estimated by an arithmetic operation, and the filter coefficient of the filter section 9a is updated with the estimated filter coefficient.

If the delay circuit 8 is not provided, the signal input to the microphone element 1 will be supplied not only to the adder 2 but also to the adaptive filter 9 with no time delay. Because the adaptive filter 9 updates the filter coefficient in such a manner as to decrease the value of the residual signal e(k), all signals supplied from the microphone element 1 will be canceled in the adder 2 by the output signals from the adaptive filter 9 as the updating of the filter coefficient progresses. For this reason, the delay circuit 8 is essential in order to cancel the feedback signal d(k) with the simulative signal do(k) while preventing cancellation of the sound source signal s(k).

As set forth above, the microphone 100 equipped with the adaptive filter 9 updates the filter coefficient on the basis of the previous residual signal e(k-τ) output from the delay circuit 8 and the current residual signal e(k) obtained by subtracting the simulative signal do(k), which is simulative of the feedback signal d(k), from the signal y(k) input via the microphone element 1. Thus, even when the gain of the closed loop, formed by the microphone element 1—amplifying path 51—speaker 7—sound feedback path 52—microphone element 1, has exceeded 1 (one) to cause unwanted howling, it is possible to cancel the howling as the time passes. Thus, even in cases where a plurality of the thus-arranged microphones are connected to the amplifier device, it is possible to thereby cancel howling for each of the microphones. Further, the microphone 100 can be connected not only to the amplifier device of FIG. 1, but also to any other ordinary or conventional amplification apparatus.

In addition, the microphone 100 arranged in the above-described manner can also be used in a manner substantially similar to the conventional microphones; for example, the microphone 100 may take the form of a handy microphone or wireless pin microphone.

### SECOND EMBODIMENT

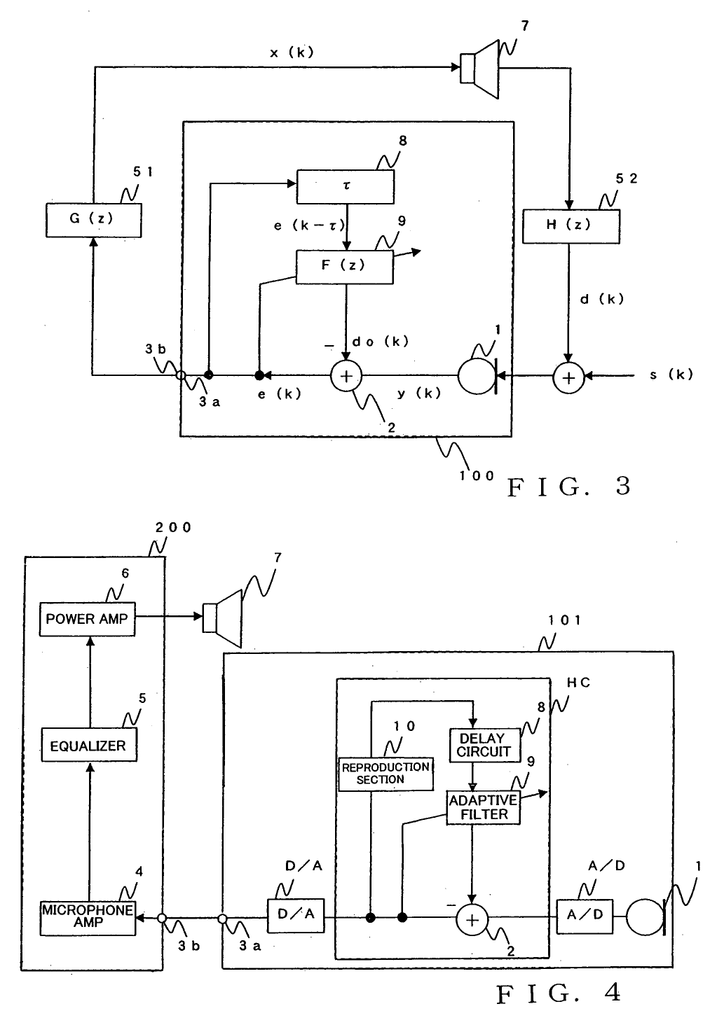

FIG. 4 is a block diagram of a sound amplification apparatus in accordance with a second embodiment of the present invention. In FIG. 4, the same components as in the first embodiment are indicated by the same reference characters and will not be described in detail here to avoid unnecessary duplication. The sound amplification apparatus according to the second embodiment includes, in place of the microphone 100 in the first embodiment, a microphone 101 where a reproduction section 10 is connected to the path between the adder 2 and the delay circuit 8.

The reproduction section 10 is implemented by a digital filter (simulating amplifier filter) that filters the output signal from the adder 2 and outputs the thus-filtered signal to the delay circuit 8. Transfer function of the reproduction section 10 is determined in advance assuming an ordinary sound amplification apparatus or the like. Thus, each signal input to the delay circuit 8 approximates a signal actually transferred to the speaker 7, so that the filter coefficient of the adaptive filter 9 can be easily identified and thus it is possible to promptly deal with occurrence of howling.

Next, a description will be given about behavior of the above-described sound amplification apparatus according to the second embodiment.

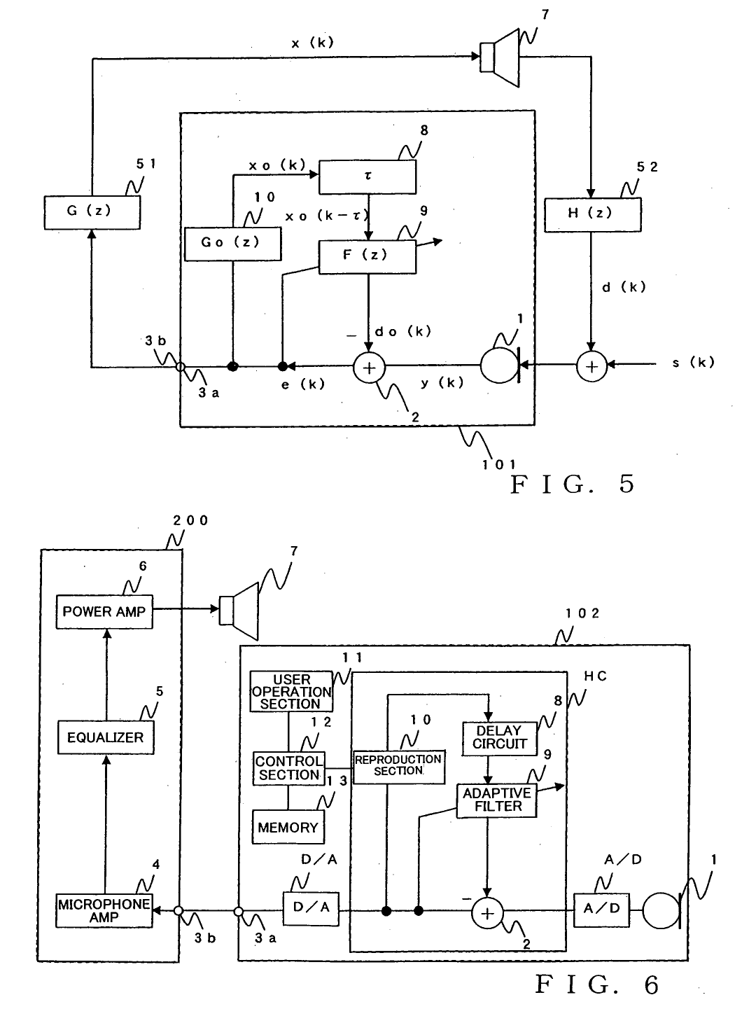

FIG. 5 is a diagram explanatory of transfer characteristics the sound amplification apparatus in accordance with the second embodiment of the present invention. As shown, the signal y(k) input via the microphone element 1 is supplied to the adder 2. The adder 2 subtracts, from the signal y(k), the output signal of the adaptive filter 9, to thereby output the residual signal e(k). The residual signal e(k) is supplied to the amplifying path 51 via the connecting terminals 3a and 3b. The amplifying path 51 represents a combination of signal transfer paths leading from the microphone element 1 to the speaker 7. Reference character G(z) represents a transfer function of the amplifying path 51.

Signal x(k) output from the amplifying path 51 is transferred to the speaker 7, via which it is audibly reproduced or sounded. Sound thus produced via the speaker 7 returns (i.e., is re-input) to the microphone element 1 via the sound feedback path 52. The sound feedback path 52 is a sound path leading from the speaker 7 to the microphone element 1. H(z) represents a transfer function of the sound feedback path 52. The feedback signal d(k) transferred via the sound feedback path 52 is input to the microphone element 1 along with a sound source signal s(k) generated by a sound source, such as a human speaker, and then the microphone element 1 again outputs these signals as the signal y(k).

The residual signal e(k) output from the adder 2 is also supplied to the reproduction section 10. The reproduction section 10 filters the supplied residual signal e(k) with a predetermined transfer function Go(z) that is preset in view of the transfer function G(z) of the amplifying path 51. Output signal xo(k) from the reproduction section 10 is transferred to the delay circuit 8.

The delay circuit 8 imparts the output signal xo(k) from the reproduction section 10 with a time delay τ corresponding to an estimated time delay of the feedback signal returning to the microphone element 1. The time-delayed previous residual signal xo(k-τ) output from the delay circuit 8 with the time delay τ is supplied to the adaptive filter 9.

The adaptive filter 9, as shown in FIG. 2, includes the filter section 9a and filter coefficient estimation section 9b, and the previous delayed residual signal xo(k-τ) output from the delay circuit 8 is supplied to both the filter section 9a and the filter coefficient estimation section 9b. The filter section 9a outputs, to the adder 2, the simulative signal do(k) that is simulative of the feedback signal d(k) returning from the speaker 7 to the microphone 1. The adder 2 subtracts the simulative signal do(k) from the signal y(k) re-input via the microphone element 1, to thereby output the current residual signal e(k). The simulative signal do(k), which is simulative of the feedback signal d(k), is determined on the basis of the signal xo(k-τ) output from the delay circuit 8 in accordance with the transfer function F(z). The filter coefficient estimation section 9b updates the filter coefficient of the filter section 9a so as to allow the simulative signal do(k) to agree with or approximate the actual feedback signal d(k), on the basis of the signal xo(k-τ) output from the delay circuit 8 and the current residual signal e(k) obtained by subtracting the simulative signal d(k) from the signal y(k) re-input via the microphone element 1 and transferred to the amplifying path 51 and using the adaptive algorithm. For example, an LMS algorithm is used as the adaptive algorithm.

As set forth above, the microphone 101, further equipped with the reproduction section 10, updates the filter coefficient on the basis of the signal xo(k), approximate to the signal transferred to the speaker 7, and the residual signal e(k) obtained by subtracting the simulative signal do(k), simulative of the feedback signal d(k), from the signal y(k) input via the microphone element 1 and delivered to the amplifying path 51. Thus, it is possible to promptly cancel howling upon occurrence of the howling. Further, the microphone 101 too can be connected not only to the amplifier device 200 of FIG. 4, but also to any other ordinary or conventional amplifier device.

The above-described sound amplification apparatus according to the second embodiment may be modified as follows. FIG. 6 is a block diagram showing a modification of the second embodiment of the present invention. In the modified sound amplification apparatus, the microphone 102 is similar to the microphone 101 of the second embodiment in that the reproduction section 10 is connected to the path leading from the microphone 1 to the delay circuit 8, but different therefrom in that it further includes a user operation section 11, control section 12 and memory 13.

The memory 13 has a plurality of different transfer functions stored therein. The control section 12 can change the transfer function of the reproduction section 10 by reading out any one of the transfer functions from the memory 13. The user operation section 11 is operable by the user to instruct switching of the transfer function. The control section 12 switches the transfer function of the reproduction section 10 to the transfer function designated by the user via the user operation section 11. Specifically, the plurality of transfer functions are prestored in the memory 13 assuming various possible amplifier devices, such as those to be used in large and small halls, auditoriums, karaoke rooms, etc. The user may freely select from among the above-mentioned preset conditions in accordance with an environment where the microphone 102 is used. In this way, each signal supplied to the delay circuit 8 can approximate the signal transferred to the speaker 7, so that howling can be canceled more accurately and promptly.

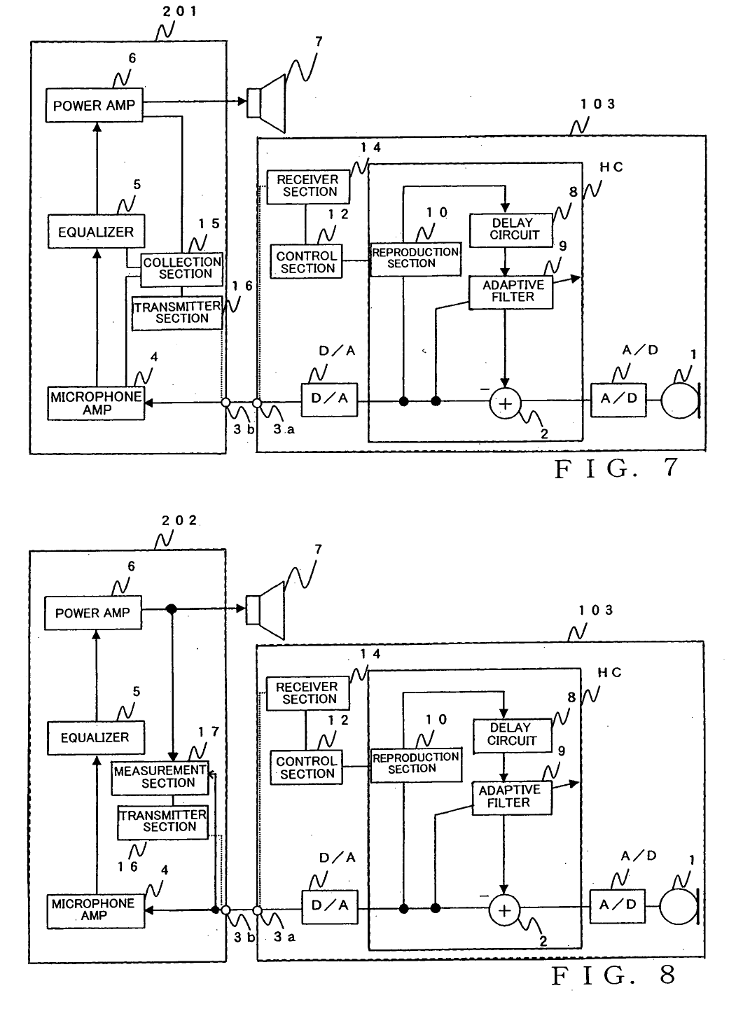

FIG. 7 is a block diagram of a sound amplification apparatus in accordance with a third embodiment of the present invention. In FIG. 7, the same components as in the first embodiment are indicated by the same reference characters and will not be described in detail here to avoid unnecessary duplication. The sound amplification apparatus according to the third embodiment includes, in place of the microphone 100 in the first embodiment, a microphone 103 where the reproduction section 10 is connected to the path leading from the microphone element 1 to the delay circuit 8 and which includes the control section 12 and receiver section 14. The sound amplification apparatus of FIG. 7 further includes, in place of the amplifier device 200, an amplifier device 201 in which a parameter collecting section 15 is connected to the microphone amplifier 4, equalizer 5 and power amplifier 6 and which also has a transmitter section 16 connected to the parameter collecting section 15.

The parameter collecting section 15 collects parameter information, such as gain and equalizing settings, of the microphone amplifier 4, equalizer 5 and power amplifier 6. The transmitter section 16 is capable of transferring the parameter information, collected by the parameter collecting section 15, to the receiver section 14 of the microphone 103. The transfer of the parameter information from the transmitter section 16 to the receiver section 14 may be carried out either by wireless communication or by wired communication. Where the connecting terminals 3a and 3b are interconnected through a wired communication unit, the parameter information may be transmitted via a cable installed between the connecting terminals 3a and 3b after being modulated with a frequency sufficiently higher than the audio frequencies. Where the connecting terminals 3a and 3b are interconnected through a wireless communication unit, on the other hand, the wireless communication unit may be constructed as a bidirectional unit to allow the parameter information to be transmitted from the amplifier device 201 to the microphone 103.

Further, in the illustrated example, the control section 12 reproduces the transfer function of the amplifier device 201 on the basis of the parameter information received via the receiver section 14, such as the gain and equalizing settings, of the microphone amplifier 4, equalizer 5 and power amplifier 6, sets the reproduced transfer function in the reproduction section 10. The reproduction section 10 filters the output signal of the adder 2 with the set transfer function and transfers the filtered signal to the delay circuit 8. In this way, each signal supplied to the delay circuit 8 can be extremely approximate to the signal actually transferred to the speaker 7, so that howling can be canceled more accurately and promptly.

The above-described sound amplification apparatus according to the third embodiment may be modified as follows. FIG. 8 is a block diagram showing a modification A of the third embodiment of the present invention. The modified sound amplification apparatus of FIG. 8 includes the microphone 103, amplifier device 202 where a transfer function measurement section 17 is connected not only to the transfer path leading from the connecting terminal 3b to the microphone amplifier 4 but also to the transfer path leading from the power amplifier 6 to the speaker 7.

The transfer function measurement section 17 receives the signal transferred over the transfer path leading from the connecting terminal 3b to the microphone amplifier 4 and the signal transferred over the transfer path leading from the power amplifier 6 to the speaker 7, and then, on the basis of a difference in characteristic between these received signals, it measures a transfer function of the transfer path leading from the power amplifier 6 to the speaker 7. The thus-measured transfer function is transferred from the connecting terminal 3b to the receiver section 14 of the microphone 103. In this case too, the transfer of the transfer function from the transmitter section 16 to the receiver section 14 may be carried out either by wireless communication or by wired communication.

The control section 12 sets the transfer function, received by the receiver section 14, in the reproduction section 10. The reproduction section 10 filters the output signal of the adder 2 with the set transfer function and transfers the filtered signal to the delay circuit 8. Thus, in the microphone 103, the input signal can be filtered with the actually-measured transfer function without arithmetic operations being performed to reproduce the transfer function.

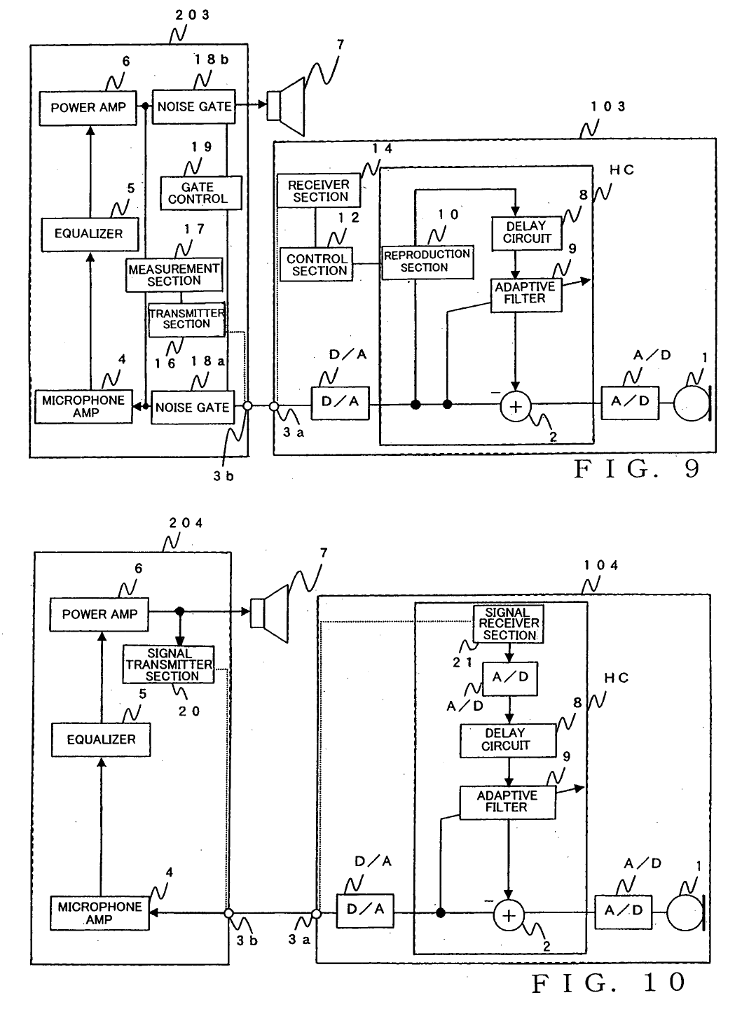

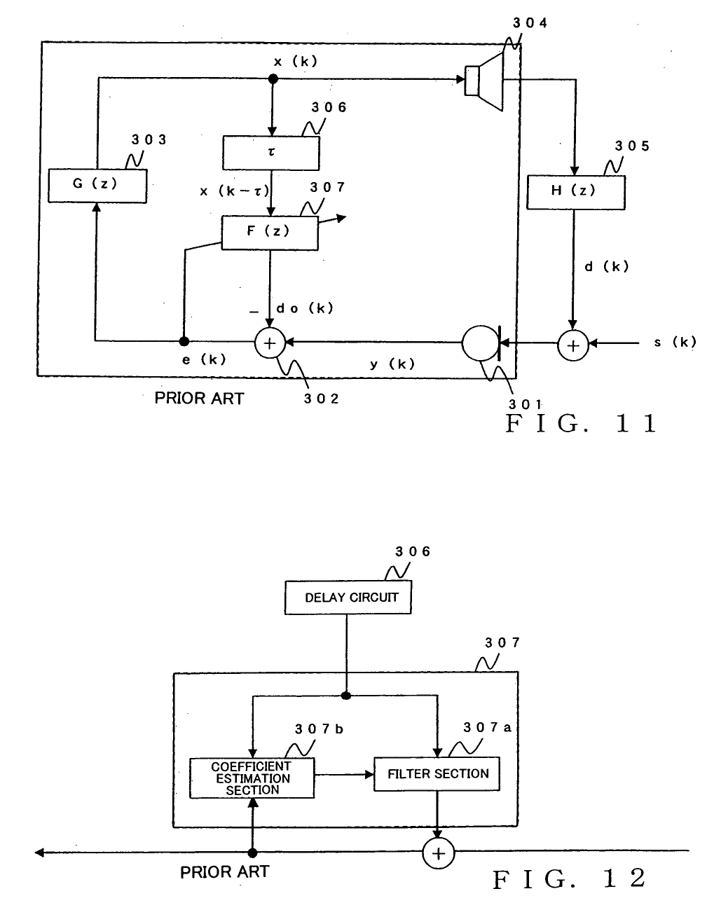

FIG. 9 is a block diagram showing a modification B of the sound amplification apparatus according to the third embodiment of the present invention. As shown, the amplifier device 203 includes a noise gate 18a connected between the connecting terminal 3b and the microphone amplifier 4, noise gate 18b connected between the power amplifier 6 and the speaker 7, and a noise gate control section 19 connected to the noise gate 18a and noise gate 18b. Further, the transfer function measurement section 17 is connected between the noise gate 18a and the microphone amplifier 4 and between the power amplifier 6 and the noise gate 18b.

The noise gates 18a and 18b each block a corresponding signal in accordance with an instruction given by the noise gate control section 19. While the noise gates 18a and 18b are blocking the signals, there exists no external input signal in the path leading from the noise gate 18a to the noise gate 18b. Further, the noise gate 18a can output a white noise or other signal in accordance with an instruction given by the noise gate control section 19. Even when the noise gate 18a outputs a white noise or other signal, the noise gate 18b can block the signal, in which case no signal is transferred to the speaker 7.

The noise gate control section 19, which is connected to the path leading from the connecting terminal 3b to the noise gate 18a, can determine presence/absence of the input signal. If the value of the input signal is equal to or less than a predetermined threshold value, the noise gate control section 19 determines that no signal is currently input to the microphone element 1, in which case the noise gate control section 19 instructs the noise gates 18a and 18b to block the signals. Further, the noise gate control section 19 instructs the noise gate 18a to output a white noise or other signal.

As noted above, the transfer function measurement section 17 is connected between the noise gate 18a and the microphone amplifier 4 and between the power amplifier 6 and the noise gate 18b. Thus, of the white noise etc. output by the noise gate 18a, the signal transferred between the noise gate 18a and the microphone amplifier 4 and the signal transferred between the power amplifier 6 and the noise gate 18b can be acquired by the transfer function measurement section 17, and then, on the basis of a difference in characteristic between these acquired signals, the transfer function measurement section 17 can measure a transfer function of the path leading from the noise gate 18a to the noise gate 18b. The thus-measured transfer function is transferred from the transmitter section 16 to the receiver section 14 of the microphone 103. Note that, in this case too, the transfer of the transfer function from the transmitter section 16 to the receiver section 14 may be carried out either by wireless communication or by wired communication.

The control section 12 sets the transfer function, received via the receiver section 14, in the reproduction section 10. The reproduction section 10 filters the output signal of the adder 2 with the set transfer function and transfers the filtered signal to the delay circuit 8. Thus, in the microphone 103, the input signal can be filtered with the actually-measured transfer function without arithmetic operations being performed to reproduce the transfer function.

With the aforementioned inventive arrangements that, when it has been determined that there is no input signal from the microphone, the external input signal is blocked and a transfer-function measuring signal, such as white noise, are used as an input signal, it is possible to measure the transfer function of the amplifier path so that howling can be canceled more accurately and promptly.

### FOURTH EMBODIMENT

FIG. 10 is a block diagram of a sound amplification apparatus in accordance with a fourth embodiment of the present invention. In FIG. 10, the same components as in the first embodiment are indicated by the same reference characters and will not be described in detail here to avoid unnecessary duplication. As shown, the sound amplification apparatus according to the fourth embodiment includes a microphone 104 provided with a signal receiver section 21 connected to the delay circuit 8, and an amplifier unit 204 provided with a signal transmitter section 20 connected between the power amplifier 6 and the speaker 7.

The signal transmitter section 20 acquires each signal to be transferred to the speaker 7 and transmits the acquired signal to the signal receiver section 21 of the microphone 104. The signal to be transferred to the speaker 7 after having been received by the signal receiver section 21, is converted via the A/D converter into a digital signal, and the thus-converted signal is supplied to the delay circuit 8. As in the above-described embodiments, the signal transfer from the signal transmitter section 20 to the signal receiver section 21 may be carried out either by wireless communication or by wired communication. Thus, the delay circuit 8 imparts a time delay to each signal to be actually transferred to the speaker 7 and outputs the thus-delayed signal to the adaptive filter 9, so that howling can be canceled more accurately and promptly.

The sound amplification apparatus according to the instant embodiment of the present invention, which employs the microphone with the adaptive howling canceler incorporated therein, can prevent unwanted howling even where it is connected with an existing amplifier device. Further, by being connected with a sound amplification unit equipped with expansion functions, such as a transfer function measurement section, the sound amplification apparatus of the present invention can cancel howling more accurately and promptly.

Further, even in cases where a plurality of the thus-arranged microphones are connected to a single amplification apparatus, it is possible to reliably cancel howling separately for each of the microphones.

The microphones described above in relation to FIGS. 1-6 may be used in any desired combination by being connected to an existing amplifier device. For example, the microphone of FIG. 1 and the microphone of FIG. 4 may be used in combination by being simultaneously connected to an existing amplifier device. In an alternative, the microphones corresponding to the amplifier devices of FIGS. 7-10 and the microphones of FIGS. 1-6 may be used in combination. For example, the microphone of FIG. 7 and the microphone of FIG. 1 may be used in combination by being connected to the single amplifier device explained above in relation to FIG. 7.

What is claimed is:

1. A microphone comprising:
a microphone element;
a simulative feedback signal generation section that generates a simulative feedback signal simulating a feedback signal generated by a sound, produced via a speaker, entering said microphone element; and
an arithmetic operator that subtracts the simulative feedback signal, generated by said simulative feedback signal generation section, from a sound signal collected by said microphone element, to thereby output a result of the subtraction as a residual signal,
wherein the residual signal outputted by said arithmetic operator is supplied to an amplifier device of the speaker as an output signal of said microphone.

2. A microphone as claimed in claim 1 wherein said simulative feedback signal generation section includes:
a delay circuit that delays the residual signal, outputted by said arithmetic operator, by a given time; and
an adaptive filter that generates the simulative feedback signal by filtering a previous residual signal delayed by said delay circuit.

3. A microphone as claimed in claim 2 wherein said adaptive filter updates a filter coefficient on the basis of the previous residual signal delayed by said delay circuit and a current residual signal outputted by said arithmetic operator.

4. A microphone as claimed in claim 2 wherein said simulative feedback signal generation section further includes, at a stage preceding said delay circuit, a simulating amplifier filter that simulates a transfer function of the amplifier device of the speaker, and said simulative feedback signal generation section filters the residual signal, outputted by said arithmetic operator, by means of said simulating amplifier filter and then supplies the filtered residual signal to said delay circuit.

5. A microphone as claimed in claim 4 which further comprises:
a memory storing a plurality of transfer functions that are respectively simulative of characteristics a plurality of types of amplifier devices usable in the speaker; and
a selector that selects any one of the transfer functions from said memory and sets the selected transfer function in said simulating amplifier filter.

6. A sound amplification system comprising:
a microphone including a sound-collecting microphone element;
an amplifier device including a signal processing circuit that amplifies, and/or adjusts sound quality of, a sound signal inputted via said microphone; and
a speaker that audibly reproduces the sound signal outputted by said amplifier device,
wherein said microphone further includes:
a simulative feedback signal generation section that generates a simulative feedback signal simulating a feedback signal generated by a sound, produced via a speaker, entering said microphone element;
an arithmetic operator that subtracts the simulative feedback signal, generated by said simulative feedback signal generation section, from the sound signal collected by said microphone element, to thereby output a result of the subtraction as a residual signal, the residual signal outputted by said arithmetic operator being supplied to said amplifier device as an output signal of said microphone; and
a simulating amplifier filter that filters the residual signal, outputted by said arithmetic operator, with a transfer function simulative of a characteristic of said amplifier device, said simulative feedback signal generation section generating the simulative feedback signal on the basis of an output signal of said simulating amplifier filter.

7. A sound amplification system as claimed in claim 6 wherein said amplifier device further includes a collection section that collects a parameter, such as a gain setting or sound quality adjustment value, set or adjusted by the signal processing circuit, and a transmitter section that transmits to said microphone the parameter collected by said collection section, and
wherein said microphone further includes a receiver section that receives the gain setting or sound quality adjustment value transmitted by said transmitter section, and a setting section that reproduces a transfer function of said amplifier device on the basis of the gain setting or sound quality adjustment value received by said receiver section and then sets the reproduced transfer function in said simulating amplifier filter.

8. A sound amplification system as claimed in claim 6 wherein said amplifier device further includes a measurement section that measures a transfer function of said amplifier device, and a transmitter section that transmits to said microphone data indicative of the transfer function measured by said measurement section, and
wherein said microphone includes a receiver section that receives the data indicative of the transfer function transmitted by said transmitter section, and a setting section that sets the transfer function, represented by the received data, in said simulating amplifier filter.

9. A sound amplification system as claimed in claim 8 wherein said amplifier device further includes:
a detector that detects a sound signal level inputted via said microphone;
a signal blockage section that, when the sound signal level detected by said detector is less than a predetermined threshold value, blocks sound signal input from said microphone to said amplifier device and sound signal output from said amplifier device to the speaker; and
a measurement signal supply section that, during blockage, by said signal blockage section, of the sound signal input and output, supplies a predetermined measurement signal to said amplifier device, said measurement signal supply section causing said measurement section to measure a transfer function of said amplifier device in response to the measurement signal supplied.

10. A sound amplification system as claimed in claim 6 wherein said simulative feedback signal generation section includes:
a delay circuit that delays the residual signal, outputted by said arithmetic operator, by a given time; and
an adaptive filter that generates the simulative feedback signal by filtering a previous residual signal delayed by said delay circuit.

11. A sound amplification system comprising:
a microphone including a sound-collecting microphone element;
an amplifier device including a signal processing circuit that amplifies, and/or adjusts sound quality of, a sound signal inputted via said microphone and
a speaker that audibly reproduces the sound signal outputted by said amplifier device,
wherein said amplifier device further includes a transmitter section that transmits to said microphone the sound signal amplified and/or adjusted in sound quality by the signal processing circuit, and
wherein said microphone further includes:
a simulative feedback signal generation section that generates a simulative feedback signal simulating a feedback signal generated by a sound, produced via a speaker, entering said microphone element;
an arithmetic operator that subtracts the simulative feedback signal, generated by said simulative feedback signal generation section, from the sound signal collected by said microphone element, to thereby output a result of the subtraction as a residual signal, the residual signal outputted by said arithmetic operator being supplied to said amplifier device as an output signal of said microphone; and
a receiver section that receives the signal transmitted by said transmitter section of said amplifier device, said simulative feedback signal generation section generating the simulative feedback signal on the basis of the signal received by said receiver section.

12. A sound amplification system as claimed in claim 11 wherein said simulative feedback signal generation section includes:
a delay circuit that delays the signal, received by said receiver section, by a given time; and
an adaptive filter that generates the simulative feedback signal by filtering a signal delayed by said delay circuit.

13. A sound amplification system as claimed in claim 12 wherein said adaptive filter updates a filter coefficient on the basis of the signal delayed by said delay circuit and a current residual signal outputted by said arithmetic operator.
